(19) United States
(12) Patent Application Publication
(10) Pub. No.: US 2011/0128535 A1
(43) Pub. Date: Jun. 2, 2011

(54) Nano-Structured Substrates, Articles, and Methods Thereof

(76) Inventors: David Eugene Baker, Bath, NY (US); Carl Wilson Ponader, Beaver Dams, NY (US); Marcel Potuzak, Corning, NY (US); Alranzo Boh Ruffin, Painted Post, NY (US); Millicent Kaye Weldon Ruffin, Painted Post, NY (US)

(21) Appl. No.: 12/952,904

(22) Filed: Nov. 23, 2010

Related U.S. Application Data
(60) Provisional application No. 61/265,169, filed on Nov. 30, 2009.

(51) Int. Cl. G01J 3/44; C03C 15/02

(52) U.S. Cl. 356/301; 216/38

(57) ABSTRACT

A nano-porous composition, a substrate thereof, and an article thereof, that can be used, for example, for Surface Enhanced Raman spectroscopy (SERS), and like applications. The disclosure also provides methods of making the nano-porous compositions, articles, and methods for SERS imaging, as defined herein.

### CLAIMING BENEFIT OF PRIOR FILED U.S. APPLICATION

This application claims the benefit of U.S. Provisional Application Ser. No. 61/265,169, filed on Nov. 30, 2009. The content of this document and the entire disclosure of any publication or patent document mentioned herein are incorporated by reference.

### BACKGROUND

The disclosure generally relates to nano-structured compositions, substrates, and articles, and to methods for making and using the compositions.

### SUMMARY

The disclosure provides nano-structured compositions, substrates, and articles thereof, that can be used, for example, for Surface Enhanced Raman spectroscopy and like applications. The disclosure also provides methods of making the nano-structured compositions, articles, and methods for SERS imaging.

### BRIEF DESCRIPTION OF THE DRAWING(S)

In embodiments of the disclosure:

FIGS. 1a and 1b, respectively, illustrate in side view a prior art SERS-active substrate and a SERS-active substrate of the disclosure;

FIGS. 2a to 2d show exemplary atomic force microscope (AFM) topographic images of phase-separated Eagle XG® glasses annealed at 790° C. or 800° C. for 12 hrs and at various acid etch times;

FIGS. 3a and 3b show atomic force microscopy (AFM) roughness profiles of phase-separated Eagle XG® glasses annealed for various times followed by acid etching;

FIGS. 4a to 4f show images and charts of the resulting surface roughness following the phase separation procedure for Eagle XG® glasses at 790° C. or 800° C.;

FIG. 5 shows a graph of the resulting surface roughness after the phase separation procedure for Eagle XG® glasses at 790° C. and 800° C.;

FIG. 6 shows the normal Raman spectra (top) and SERS-enhanced spectra (bottom) of methylene blue dye on phase separated Eagle XG® glass;

FIGS. 7a to 7b show representative spectra of methylene blue dye on gold coated phase-separated Eagle XG® at different anneal times and temperatures compared to a control (top trace);

FIG. 8 show representative spectra (intensity v wave number (cm⁻¹)) of methylene blue dye on gold coated phase-separated Eagle XG® that had been prepared with different anneal times and temperatures compared to a commercially available substrate;

FIGS. 9a to 9d show ellipsometric images of un-annealed (FIG. 9a) and annealed (FIGS. 9b to 9d) glass (721-YJ) substrates;

FIG. 10 shows a SERS spectrum of 10⁻⁴ M methylene blue on annealed glass (721-YJ) substrates that were annealed at various temperatures; and

FIGS. 11a to 11e show phase diagrams, in mol %, for various phase-separated systems.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments for the claimed invention.

### DEFINITIONS

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example, to a composition, to a method of making or using the composition, and articles, devices, or any apparatus of the disclosure, and can include the components or steps listed in the claim, plus other components or steps that do not materially affect the basic and novel properties of the compositions, articles, apparatus, or methods of making and use of the disclosure, such as particular reagents, particular additives or ingredients, a particular agents, a particular surface modifier or condition, or like structure, material, or process variable selected. Items that may materially affect the basic properties of the components or steps of the disclosure or that may impart undesirable characteristics to the present disclosure include, for example, insufficient annealing, insufficient etching, excessive or unnecessary surface metallization, and like contrary steps.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “RT” for room temperature, “nm” for nanometers, and like abbreviations).

Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

In embodiments, the disclosure provides nano-structured compositions, substrates, and articles thereof, as defined herein, and methods for making and using the nano-structured compositions.

In embodiments, the disclosure provides nano-structured compositions, substrates, and articles thereof, which can be used, for example, for Surface Enhanced Raman Spectroscopy (SERS), Surface Enhanced Resonance Raman Spectroscopy (SERRS), Single-Molecule-Surface Enhanced Resonance Raman Spectroscopy (SM-SERRS), and Nano-Structured Surface Enhanced Raman Spectroscopy (NS-SERS) applications.

Phase-separated Eagle® XG (PSEXG), micro-reactor (721-YJ), and 722 XK (7740 Pyrex®) glass substrates exhibit the significant attributes for surface-enhanced Raman spectroscopy. Depending on the process conditions, the feature sizes formed by the phase-separation of Eagle® XG, micro-reactor (721-YJ), and 722 XK (7740 Pyrex®) glass are on the order of about 2 to about 20 nm. The surface morphology can be considered as fractal having curvaceous and sharp structures of about 1 to about 10 nm spacing, which morphologies have proven ideal for SERS activation (see G. Kartopu, et al., “A novel SERS-active substrate system: Template-grown nanodot-film structures,” Physica Status Solidi A-Applications And Materials Science, vol. 203, pp. R82-R84, August 2006). The phase-separation process yields a uniform fractal structure over the entire treated surface area and thus eliminates the formation of “hot spots.” The phase-separated Eagle® XG, micro-reactor (721-YJ), and 722 XK (7740 Pyrex®) glass substrates are made SERS-active by applying a thin layer of metal, such as gold (Au), silver (Ag), or like noble metal, and a combination thereof.

Eagle® XG compositions are disclosed in commonly owned and assigned Corning, Inc., U.S. Pat. Appln Publication No. 2006/0293162, U.S. Ser. No. 11/478,493, entitled “Fining of Boroalumino Silicate Glasses.” Unlike other platforms for SERS, such as metal island films, metal-coated nanostructures, or porous glass-ceramics, the nano-structures of phase-separated Eagle® XG substrates can be readily made SERS-active and in fewer process steps compared to other SERS platforms. The phase-separated Eagle® XG substrates can be easily manufactured using available technology such as used in making liquid crystal display (LCD) glass, and can use, for example, recycled or scrap glass. Additionally, tedious and time-consuming surface preparation processes can be eliminated as discussed further below.

In embodiments, the compositions, articles, and processes of the disclosure can provide some or all of the following useful features.

Simplified Processing The process reduces process time and educes the number of process steps compared to metal-ion doped sol-gels formed by hydrolysis (see P. Permasiri, “Characterization of the Surface Enhanced Raman Scattering (SERS) of Bacteria,” J. Phys. Chem. B, vol. 109, 2005), electrochemical roughening of electrode surfaces (see K. L. Norrod, “Quantitative Comparison of Five SERS Substrates: Sensitivity and Limit of Detection,” Applied Spectroscopy, vol. 51 pp. 994-1001, 1997, and etching of glass-ceramic substrates (see Z. Pan, et al., “Surface-enhanced Raman probing of biomolecules using Ag-coated porous glass-ceramic substrates,” Journal of Raman Spectroscopy, vol. 36, pp. 1082-1087, (2005)). For example, a recently reported by Pan et al., porous glass-ceramic substrate also exhibited excellent attributes for SERS analysis. However, the sample required about 216 hrs of preparation. This glass-ceramic composition of the CaO—TiO₂—P₂O₅ (CTP) system was made porous by first crystallization and second chemical leaching. The chemical composition of the base glass is 45CaO.25TiO₂.30P₂O₅ plus 2Na₂O (mol %). The starting materials were regent-grade CaCO₃, TiO₂, P₂O₅, and NaCO₃ powders. These starting materials were mixed with distilled water to make a slurry. The dried products of the slurry were used as batches. The glass was prepared using the melt-quench method and was cut into small pieces (10×5×2 mm) Two large parallel surfaces of each glass sample were polished. They were then heat-treated at 690° C. for 24 hours, and 760° C. for 48 hours, forming two precipitated phases, CaTi₄(PO₄)₆ and β-Ca₃(PO₄)₂. The first heat treatment step is for nucleation and the second heat treatment step is for crystal growth. The resulting glass-ceramics were further leached with 0.1 N hydrochloric acid solution for 7 days. The β-Ca₃(PO₄)₂ phase was selectively dissolved out, leaving a crystalline CaTi₄(PO₄)₆ skeleton. The resulting porous material had a weight loss of about 15%. The surface area and mean pore radius of the porous glass-ceramics was about 45 m²/g, and 40 nm, respectively. For further details see Pan, ibid. and Z. Pan, et al., “Surface-enhanced Raman spectroscopy using silver-coated porous glass-ceramic substrates,” Applied Spectroscopy, vol. 59, 782-786, 2005. In contrast, the present process can be accomplished in considerably less total time, for example, from about 5 to about 70 hours.

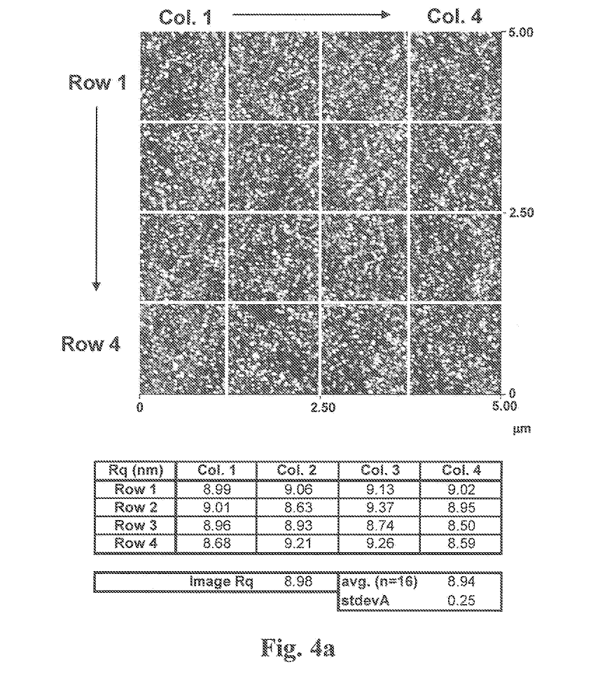

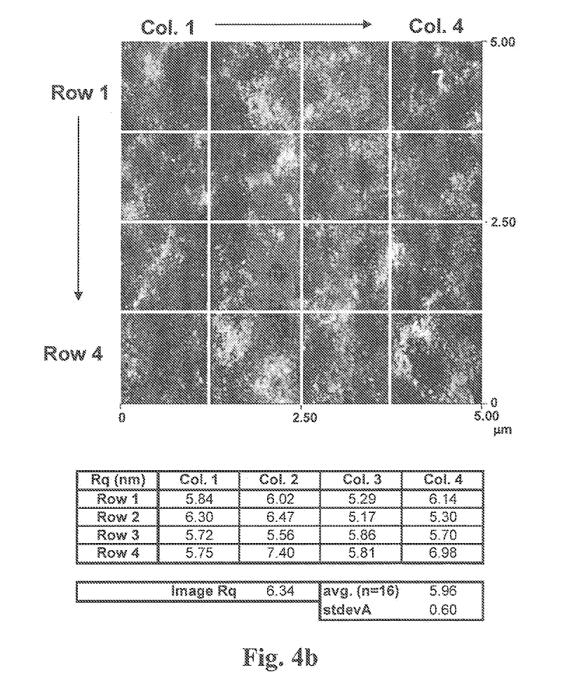

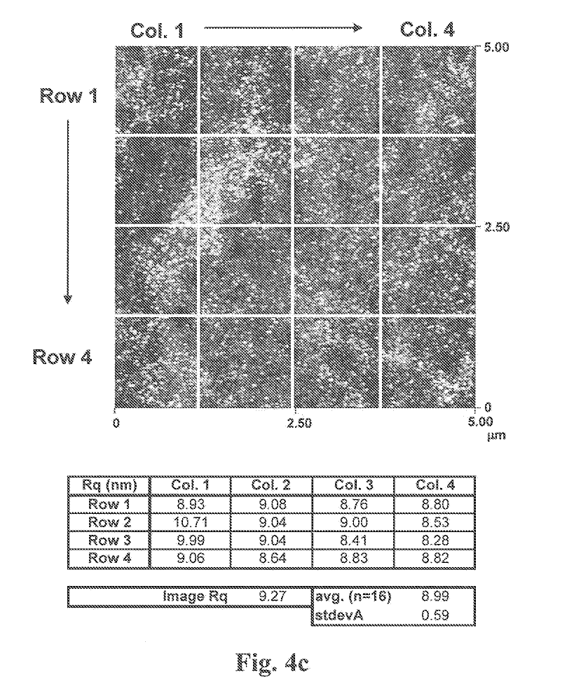

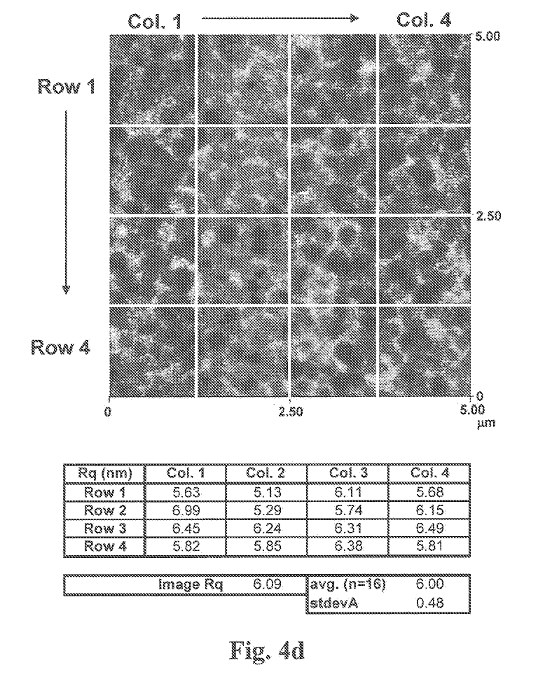

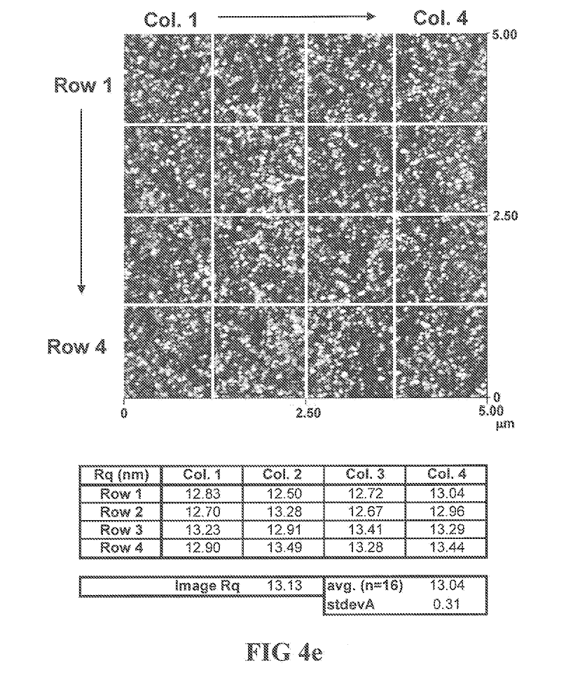

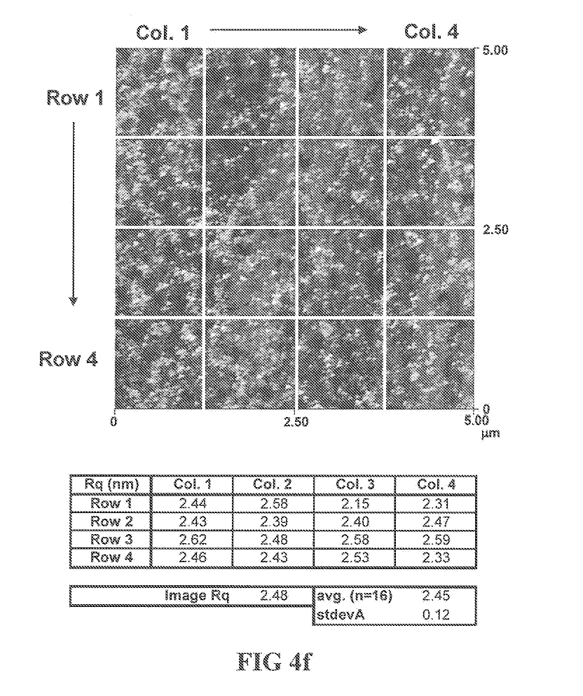

High Uniformity and Reproducibility The process provides substrates having highly uniform randomness and the process has high reproducibility as suggested by FIGS. 4a to 4f.

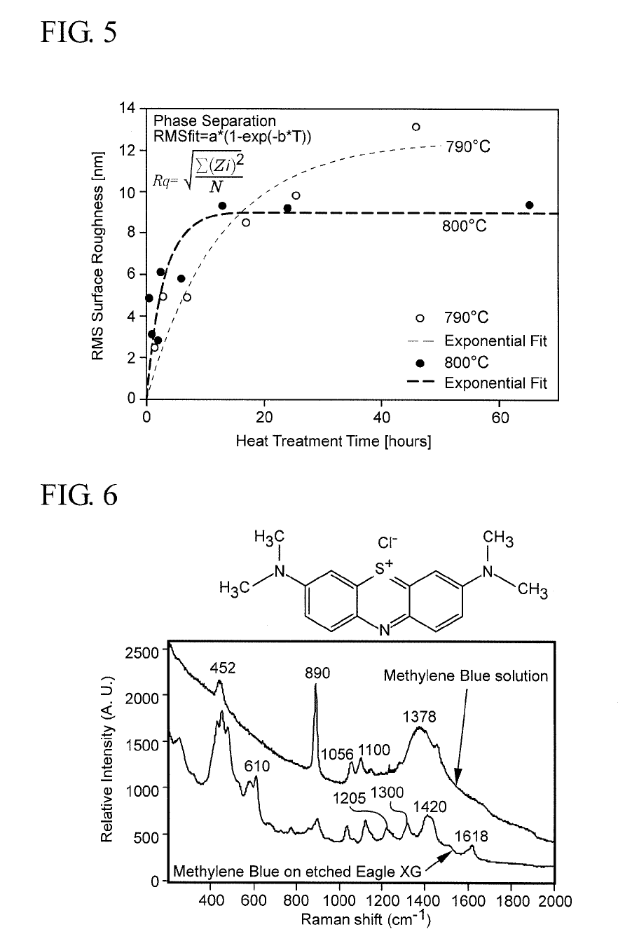

Control of Surface Topology The process provides control of surface topology which enables one to tailor surface roughness to a variety of molecule sizes and dimensions as exemplified by FIG. 5. In embodiments, the etched article can be a double-sided surface.

Signal Enhancement The enhanced Raman signal arising from the disclosed articles is comparable to or better than a commercially available photolithographic SERS-active substrate (Klarite™; www.d3diagnostics.com) as illustrated in FIG. 6.

Surface-enhanced Raman spectroscopy or scattering (SERS) provides Raman spectroscopy structural information that can be enhanced to an ultra-sensitive detection limit, which allows the SERS technique to be used for spectroscopy of single molecules. The electromagnetic field of light near the surface can be greatly enhanced under conditions of surface plasmon excitation.

Although not bound by theory, it is generally believed that SERS sensitivity enhancement results from the amplification of the Raman signal due to electromagnetic effects, chemical effects, or both. The electromagnetic effect can result from enhanced scattering in the local optical fields close to surface of metallic particles or films after excitation of surface plasmons at resonance conditions. The chemical effect, while a smaller contributor to the overall SERS enhancement, can arise from the formation of a charge transfer complex between the vibrational level of an adsorbed molecule and an excited energy level of the metal. The result is a slightly larger Raman cross-section (see E. D. F. Giorgis, et al., “Porous silicon as efficient surface enhanced Raman scattering (SERS) substrate,” Applied Surface Science, vol. 254, 7494-7497, 2008).

An excellent review of SERS analysis and application is, for example, K. Kneipp, et al., Journal of Physics-Condensed Matter, 14, R597 (2002). A review of surface plasmons is, for example, W. L. Barnes, et al., Nature 424, 824 (2003). SERS is a vibrational spectroscopy having extremely high spatial resolution. SERS can provide ultra-sensitive detection and characterization of many organic and bio-medically relevant molecules. SERS can be an effective tool for analytical chemistry, biology, drug discovery, and like fields. SERS can also provide a cost-effective method for sensing (e.g., remote) biological or chemical threats for security applications where the SERS-active substrates can be prepared cost effectively. The activation process of SERS for the high sensitivity detection can have a rough metallic feature, compatibility with molecules under investigation, or both. The compatibility provides improved coupling between absorbed sample molecules and the metallic surface. A good SERS substrate is one that is easy to prepare, reproducible, stable, and compact in size.

In embodiments, the disclosure provides porous nanostructured SERS substrates and methods for making the substrates.

In embodiments, the disclosure provides a substrate based on metal-covered nano-porous articles for use as a solid-surface SERS substrate. These solid-surface substrates offer relatively good reproducibility in surface characterization, i.e., surface roughness characteristics (e.g., about 1-5% relative standard deviation for the exemplary cases).

In embodiments, the disclosure provides a process for controlling the surface nano-feature size of a phase-separated borosilicate glass composition, comprising:

annealing the borosilicate glass composition at just below the melting point of the glass for about 0.5 to about 200 hours;

contacting the resulting phase-separated glass with a suitable etchant for about 0.5 to about 120 minutes to dissolve one phase from the annealed borosilicate glass and to produce at least one porous surface; and

depositing a metal layer on the at least one porous surface.

The annealing can be accomplished, for example, at from about 750 to about 800° C. in from about 30 to about 65 hours. The contacting to dissolve one phase can be accomplished, for example, by treating the glass with a strong acid to dissolve the silica-rich phase, or treating the glass with a strong base to dissolve the boron-rich phase. The contacting with a suitable etchant can be accomplished, for example, in from about 20 to about 30 minutes.

The depositing the metal on the surface can be accomplished, for example, by sputtering, epitaxy, and like methods, or a combination thereof. The depositing the metal layer on the at least one porous surface can be accomplished, for example, to a thickness of from about 1 to about 5,000 nm. The process can further include, for example, depositing metal on an opposing un-contacted, i.e., no etchant exposure, side of the substrate to a thickness of from about 1 to about 5,000 nm. In embodiments, substrates having a metallic coat on both the top (etched) and bottom (non-etched or un-contacted) sides of the substrate or plate can further enhance reflectance of the substrate article. The annealing can be accomplished, for example, at from about 750 to about 800° C. in from about 30 to about 65 hours, and contacting with a suitable etchant can be accomplished, for example, in from about 20 to about 30 minutes.

The resulting at least one porous surface has pores having fractal particles within the pores, the pores having a width to height aspect ratio of from about 1:5 to about 50:200. The pores can have, for example, a width of about 1 nm to about 50 nm and a height of about 5 nm to about 200 nm having and the fractal particles can have a diameter of about 1 to about 20 nm. In embodiments, the deposited metal layer can have a thickness of about 1 to about 500 nm. The substrate can have, for example, high optical clarity or transparency of, for example, from about 90 to about 99.5 percent transparency. The phase-separated borosilicate glass composition can be, for example:

a stable phase separation in the SiO₂—B₂O₃—RO system;

a metastable phase separation in the SiO₂—B₂O₃—R₂O system;

a metastable (sub-liquidus) phase separation in the SiO₂—B₂O₃—Na₂O system;

a metastable phase separation in the system SiO₂—B₂O₃—Li₂O;

a metastable phase separation in the SiO₂—B₂O₃—Na₂O system;

a metastable phase separation in the SiO₂—B₂O₃—K₂O system;

or a combination thereof,

where RO and R₂O comprise at least one of P₂O₅, MgO, CaO, SrO, BaO, GeO₂, TeO₂, SeO₂, As₂O₃, Sb₂O₃, V₂O, Na₂O, Li₂O, K₂O, or a combination thereof. A source of the borosilicate glass prior to disclosed phase-separation can be, for example, Eagle XG® (2000F), Microreactor glass (721YJ), Microreactor glass (722XK) Vycor®, Pyrex®, and like compositions, or a combination thereof.

In embodiments, the disclosure provides a process for generating nanoscale features on a rigid, transparent substrate comprising:

sputtering atoms from a solid target onto the substrate, depositing partially sintered metal oxide soot onto the substrate, or a combination thereof, the solid target is a glass, a metal oxide soot, or a combination thereof, and the substrate is selected, for example, from the abovementioned phase-separated borosilicate glass compositions.

In embodiments, the disclosure provides a SERS-active substrate comprising an article prepared according to the above process including annealing; contacting with an etchant; and depositing a metal layer on the at least one porous surface.

In embodiments, the disclosure provides a method of making a SERS active substrate comprising:

annealing a borosilicate glass composition at about 750 to about 800° C. for about 0.5 to about 65 hours;

contacting the resulting phase-separated glass with an etchant to dissolve one phase from the annealed borosilicate glass, and

depositing a metal layer having a thickness of from about 1 to about 5,000 nm on the etched surface of the resulting porous glass.

The method can further comprise depositing a metal layer having a thickness of from about 1 to about 5,000 nm on an opposing non-etched surface of the resulting porous glass. The surface roughness of the etched surface increases with an increase in annealing time.

In embodiments, the disclosure provides a method of SERS imaging comprising:

providing a SERS active substrate prepared according to the above process having a surface roughness based on the pores having a width to height aspect ratio of from about 1:5 to about 50:200;

providing an analyte to the surface of the SERS active substrate;

irradiating the analyte on the substrate; and

recording the light spectrum reflected from the substrate. In embodiments, it is noted that the substrate is free of hot-spots, the background fluorescence decreases with an increase in the annealing period, and the signal-to-noise increases as the annealing period increases. In embodiments, the analyte can orient perpendicular to the macroscopic or microscopic plane of the substrate's etched surface and within the pores of the etched substrate.

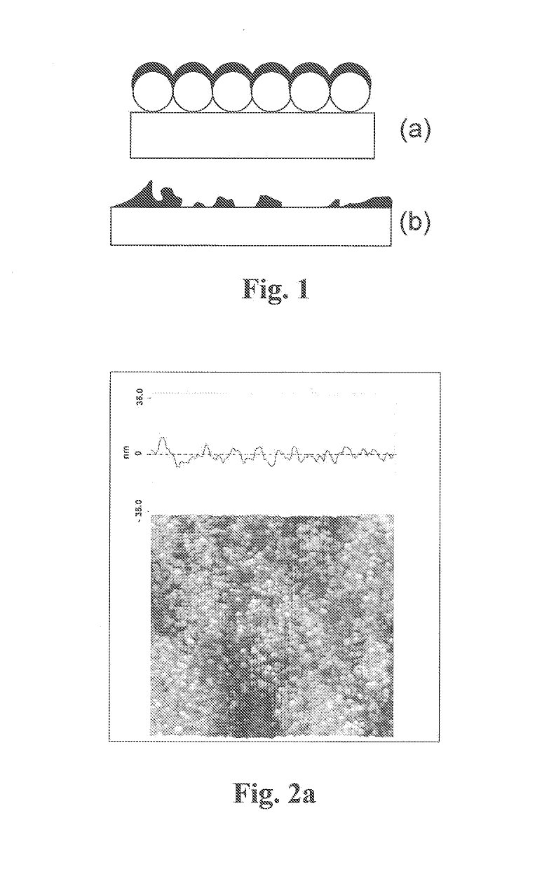

Referring to the Figures, FIG. 1 a shows a schematic of a known (see Vo-Dihn, et al., “Surface-enhanced Raman Scattering (SERS) Method and Instrumentation for Genomics and Biomedical Analysis,” Journal of Raman Spectroscopy, vol. 30, pp. 785-794, (1999)) SERS-active substrate having particles deposited thereon and a metal layer thereover. FIG. 1b shows a schematic of a SERS-active substrate of the present disclosure having a random etched nano-structured surface and further having a metal layer (not shown) thereover.

In many applications which require thin, fusion drawn glass substrates, the glass typically should remain compositionally homogenous throughout, i.e., from surface to surface. In embodiments, the SERS-active substrate can be used in, for example, biomedical or biophotonic sensors.

In embodiments, the disclosure provides a method of making a SERS-active substrate comprising, for example, a three step process including annealing, etching, and metalizing a glass to provide dense nanostructures at the glass surface(s). The resulting nano-structured surfaces are especially suitable for Surface Enhanced Raman Scattering (SERS) activation. In embodiments, an especially useful SERS-active substrate is, for example, a substrate having random or periodic features that can provide enhancement of Raman signals for analytical chemical analysis.

Available methods for preparing such SERS-active substrates are expensive, and use, for example, low-volume, low-yield photolithographic processes. In embodiments, the disclosure provides a method to control the dense, random morphology of a SERS-active surface obtained from processing a glass composition, such as Eagle® XG glass commercially available from Corning, Inc. Feature sizes of the resulting nano-structured surface can be manipulated or tailored by changing the anneal time. The disclosed preparative method and the resulting glass-ceramic products can provide SERS surfaces that have morphological features with greater latitude and that can accommodate various molecular dimensions or other probe wavelengths.

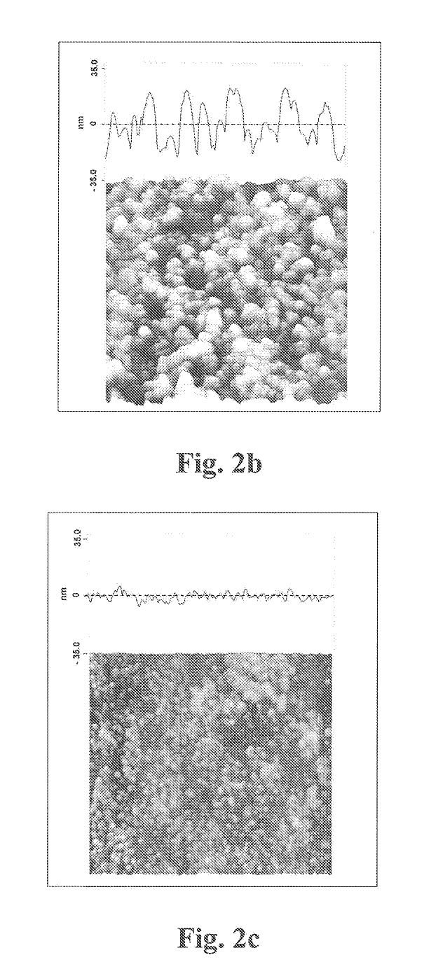

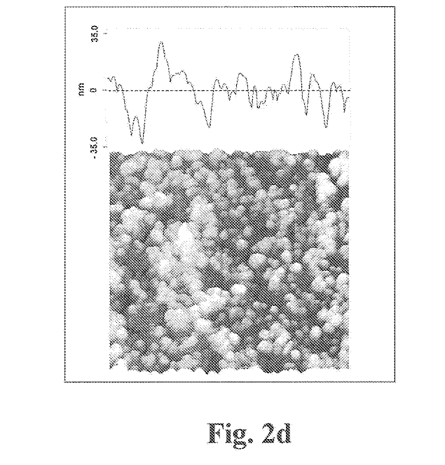

In embodiments, the control of nanostructure on the surface of selected glass substrates can be accomplished through controlled phase-separation. First, substrates are annealed at about 750 to about 800° C., for about 0.5 to about 65 hours, to separate the material into two continuous phases, one rich in silica, and the other in borosilicate and alkali. The resulting glass is further process at ambient temperature (about 25° C.) as follows: etching with, for example, a dilute acid solution for about 0.5 to about 30 mins to dissolve the boron-rich phase. This leaves some small colloidal silica particles inside the pores of the other phase. The product was rinsed with de-ionized (DI) water, then with 3% boric acid, then DI water, and then allowed to air dry. The surface morphology of these substrates was examined and found to have colloidal silica spheres of from about 1 to about 20 nm. FIGS. 2a to 2d show exemplary AFM image topographic images of phase-separated Eagle XG® glasses annealed at 790° C. or 800° C. for 12 hrs at various etching times as listed in the accompanying table.

| FIG. | Anneal temp (° C.), Etch time, image area, RMS |
|---|---|
| 2a | 790° C., 3 hr, 1 micrometer², 3.5 nm |
| 2b | 790° C., 46 hr, 1 micrometer², 14.2 nm |
| 2c | 800° C., 2 hr, 1 micrometer², 10.6 nm |
| 2d | 800° C., 65 hr, 1 micrometer², 10.6 nm |

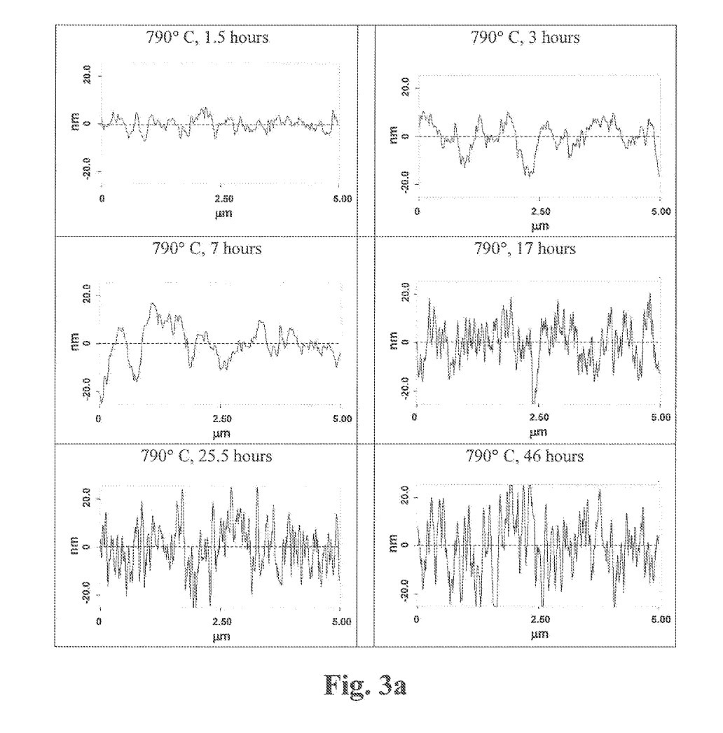

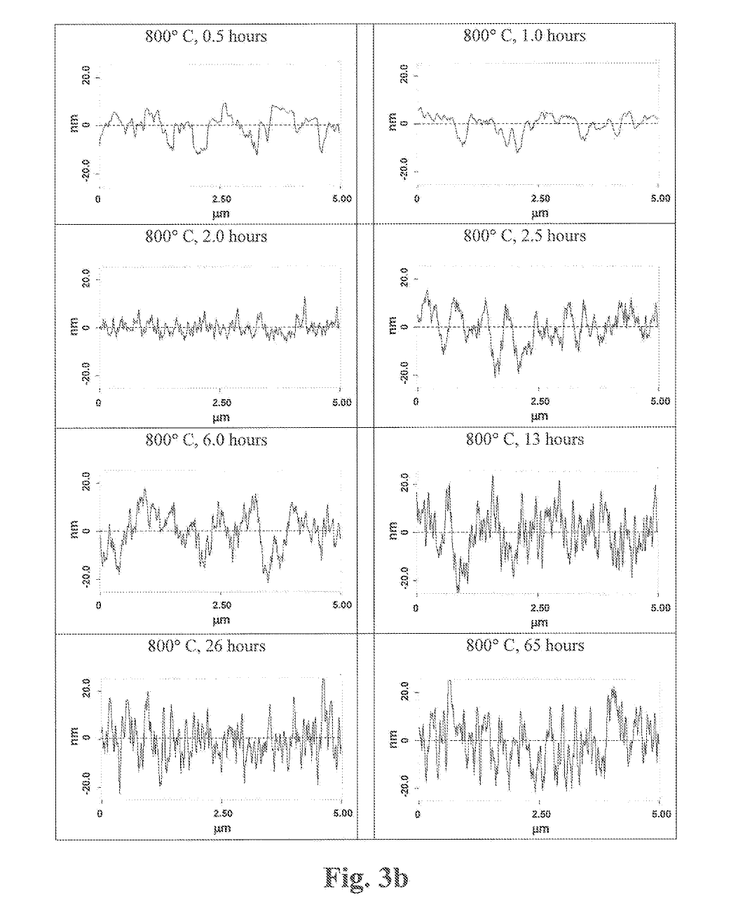

The anneal and etch conditions can significantly influence the colloidal feature size. FIGS. 3a and 3b show atomic force microscopy (AFM) images of Eagle XG® samples annealed for various periods and then acid etched, in embodiments of the disclosure. Eagle XG® samples were annealed at 790° C. (FIGS. 3a.1 to 6) for a set time intervals, such as 1.5, 3, 7, 17, 25.5, and 46 hrs, or 800° C. (FIGS. 3b.1 to 8) for a set time intervals, such as 0.5, 1, 2, 2.5, 6, 13, 24, and 65 h, and then all samples were individually etched with 3 M HF for 3 min. As the annealing time increases the depth of the pits or valleys increase, but interstitial spacings on the order of a few nanometers are maintained, thus making the resulting surface more ideal for SERS activation. In the atomic force microscopy (AFM) section analysis of FIGS. 3a.1 to 6 and FIGS. 3b.1 to 8, there is illustrated the effect anneal time on the surface morphology; that is, the surface roughness and feature size(s) can be increased with increasing anneal time as a result of the silica-rich and boron-rich phases being isolated or separated from on another. The phase-separation process also generates a uniform morphology across the entire treated surface area as indicated in FIGS. 4a to 4f. The FIGS. 4a to 4f show images and charts of the resulting surface roughness following the phase separation procedure for Eagle XG® glasses at 790° C. or 800° C. FIG. 4a shows an image of an Eagle XG® specimen that was annealed at 800° C., for 13 hours, and then etched with 10% HF for 5 minutes. The uniformity of the root mean square roughness (R_{q}) within 25 micrometers² was confirmed by superimposing a 4×4 grid on a 5 micrometer AFM image and measuring the Rq roughness of each square. The R_{q} roughness from each grid is compiled in the accompanying tables. The average R_{q} roughness from the sixteen squares was found to be the same as the R_{q} roughness calculated from the whole image. FIG. 4b shows an image of an Eagle XG® specimen that was annealed at 800° C., for 13 hours, and then etched with 10% HF for 1 minute. FIGS. 4c shows an image of an Eagle XG® specimen that was annealed at 800° C., for 13 hours, and then etched with 5% HF for 3 minutes. FIG. 4d shows an image of an Eagle XG® specimen that was annealed at 800° C., for 2.5 hours, and then etched with 5% HF for 3 minutes. FIG. 4e shows an image of an Eagle XG® specimen that was annealed at 790° C., for 46 hours, and then etched with 5% HF for 3 minutes. FIG. 4f shows an image of an Eagle XG® specimen that was annealed at 790° C., for 1.5 hours, and then etched with 5% HF for 3 minutes.

FIG. 5 shows a graph of the resulting surface roughness after the phase separation procedure for Eagle XG® glasses at 790° C. and 800° C. The results demonstrate anneal and the etch conditions for producing a variety of phase-separated Eagle XG® substrates. FIG. 5 demonstrates the effect of both anneal time and temperature on the nanostructures. The RMS surface roughness can be worked to yield a variety of colloidal feature sizes. This can be advantageous for SERS applications where an analyte might require larger or smaller colloids to realize the greatest SERS detection sensitivity. The substrates can be made SERS-active by applying about 5 to about 20 nm layer of a noble metal, such as Ag, Au, Pt, or like metals. FIG. 5 shows comparative normal Raman and SERS of a methylene blue dye solution on phase-separated Eagle XG®. The substrate was prepared as follows: anneal at 790° C. for 90 min; and etched for three hours with 5% HF and 10% HNO₃

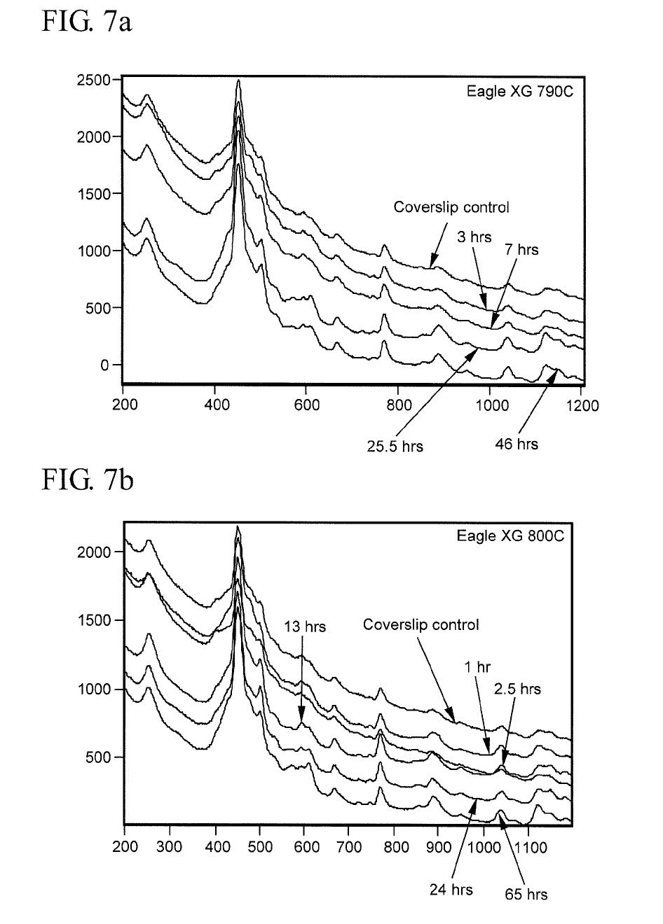

In embodiments, the disclosure provides actual examples of the phase-separated Eagle XG® that are rendered SERS-active as shown in FIGS. 6 and 7. The Raman spectra were collected on an Instruments SA T64000 with a liquid-nitrogen cooled CCD. Excitation wavelength, laser output power, and incident spot size were 785 nm, 25 mW, and 2 microns, respectively. Methylene Blue (C₁₆H₁₈N₃ClS) in an ethanol solution was chosen as the test analyte and was diluted to 10⁻⁴ M. 5 microL of this solution was applied over approximately 1 cm² of substrate area. After the ethanol was evaporated a second 5 microL portion of the dye solution was applied and allowed to dry. It is estimated that only a monolayer of methylene blue remained on the SER-active, phase-separated Eagle XG®. Spectra were collected at ambient temperature in back-scattering mode. Rayleigh scattering rejection was done with a dielectric notch filter. FIG. 6 compares the normal Raman spectra (620) of methylene blue in ethanol solution with the SERS spectra (640) of methylene blue after adsorption onto the phase separated Eagle XG® substrate. The normal Raman spectra (620) shows only two bands from the methylene blue (452 cm⁻¹ and 1378 cm⁻¹). The remaining bands are contributions from the ethanol solvent (see W. Chu, et al., Catalysis Communications, 3 (2002), 547-552). The SERS spectra (640) shows significant detail which is not apparent in the normal Raman spectra. The C—N—C stretch (452 cm⁻¹) is of higher intensity and displays as a triplet in the SERS spectra. The CSC stretch is evident at about 610 cm⁻¹. Asymmetric and symmetric C—N stretches are evident at 1300 and 1420 cm⁻¹, respectively. Additionally, the ring stretch mode appears at 1618 cm⁻¹ (see Naujok, R. R., et al., Langmuir, 9 (1993) 1771-4). The power of SERS is evident in this spectral example. More information can be obtained using SERS to probe this molecule. As the surface concentration of the molecule changes the spectra may also change to indicate either monolayer or multilayer coverage (see Nicolai, S. H. A., et al., Langmuir, 19 (2003) 4291-4).

FIGS. 7a and 7b show representative spectra (lower traces) of methylene blue dye on gold coated phase separated Eagle XG® at different anneal times and temperatures compared to a covers slip control (top trace). FIGS. 7a (Eagle XG® 790° C. anneal temperature) and 7b (Eagle XG® 800° C. anneal temperature) demonstrate the importance of anneal time and temperature on the materials performance of a SERS substrate. The spectra are truncated to focus on the C—N—C stretch at 450 cm⁻¹. As the anneal time is increased (FIG. 7a: 3 hrs, 7 hrs, 25.5 hrs, and 46 hrs; FIG. 7b: 1 hr, 2.5 hrs, 24 hrs, and 65 hrs) the SERS activity of the metal film increases. This is supported by the evolution of a shoulder band at 500 cm⁻¹ and the narrowing of the C—N—C stretch. As the anneal time increases and the roughness features approach dimensions ideal for SERS, the number of bands and resolution of the bands in the SERS spectra increases accordingly. The results demonstrate an improved signal-to-noise ratio compared to a simple SERS-active substrate without nanostructure features.

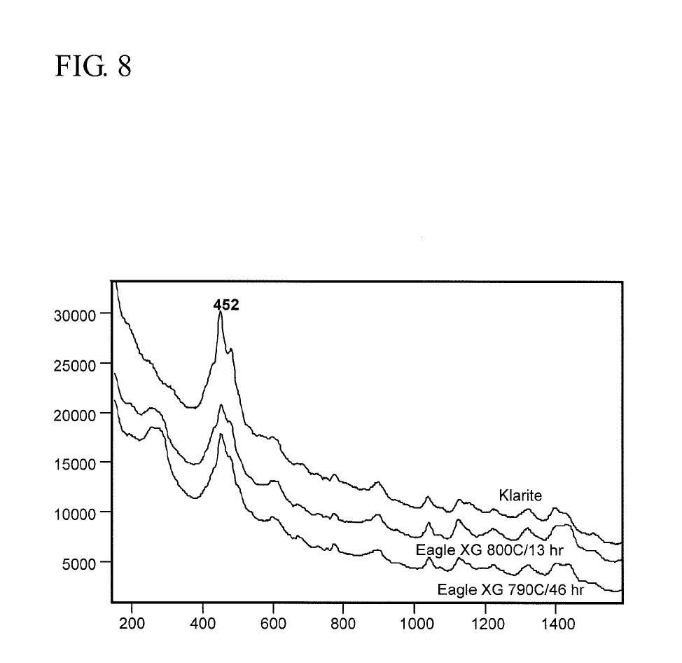

FIG. 8 show representative spectra (intensity versus wave number (cm¹)) of methylene blue dye on gold coated phase-separated Eagle XG® that had been prepared with different anneal times and temperatures (Eagle XG® 800° C., 13 hrs; middle trace) (Eagle XG® 790° C., 46 hrs; bottom trace) compared to a commercially available substrate (Klarite™; top trace).

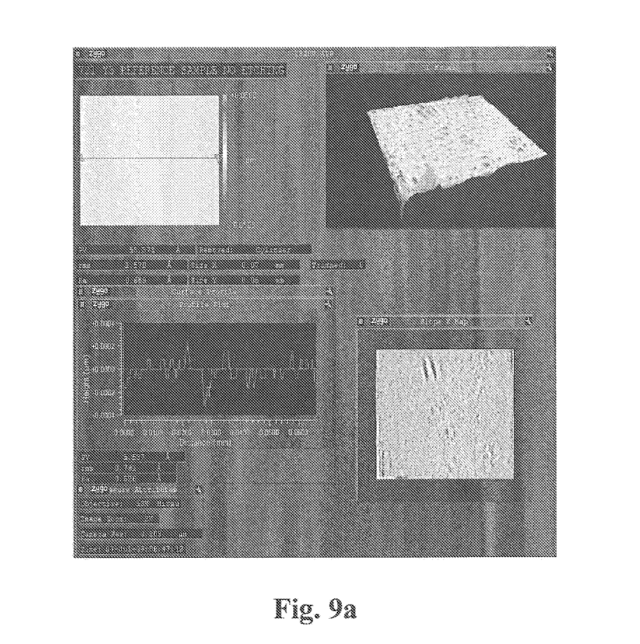

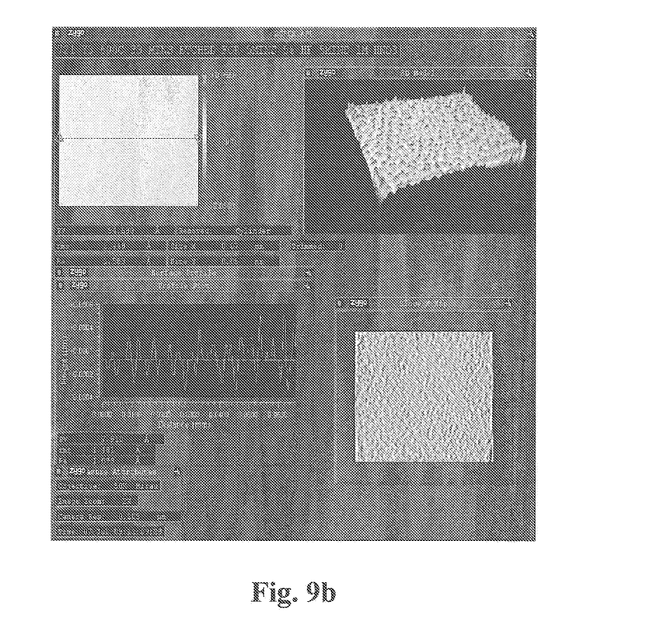

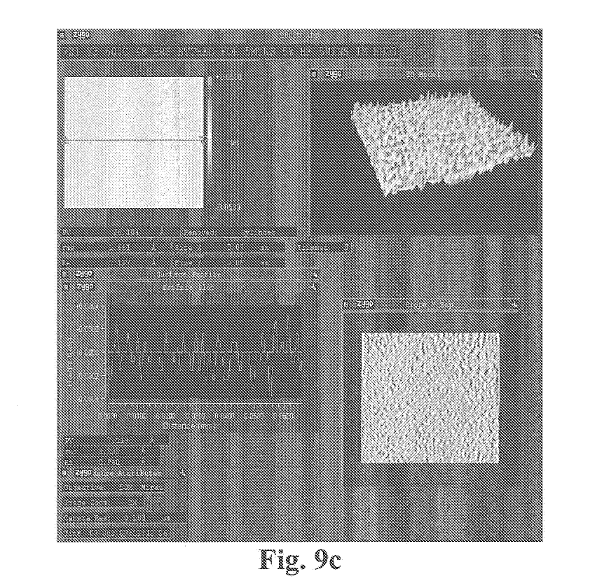

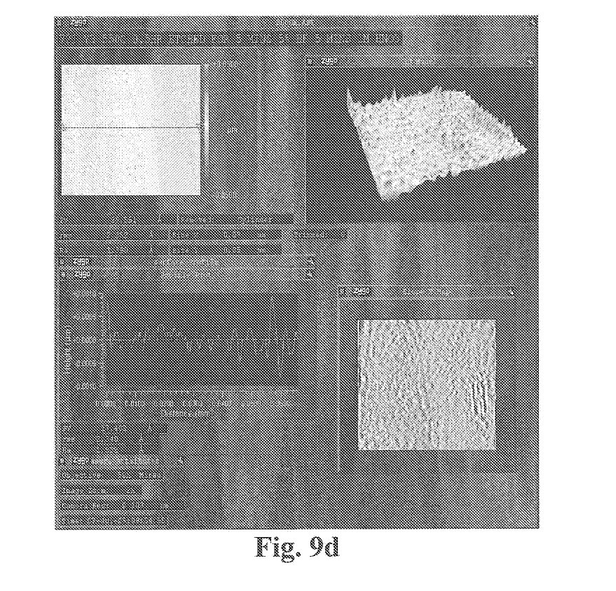

FIGS. 9a to 9d show ellipsometric images of a comparative un-annealed (FIG. 9a) and annealed (FIGS. 9b to 9d) glass (721-YJ) substrates. The sample in FIG. 9b was annealed for 33 minutes. The sample in FIG. 9c was annealed for 48 hrs. The sample in FIG. 9d was annealed for 6 hrs.

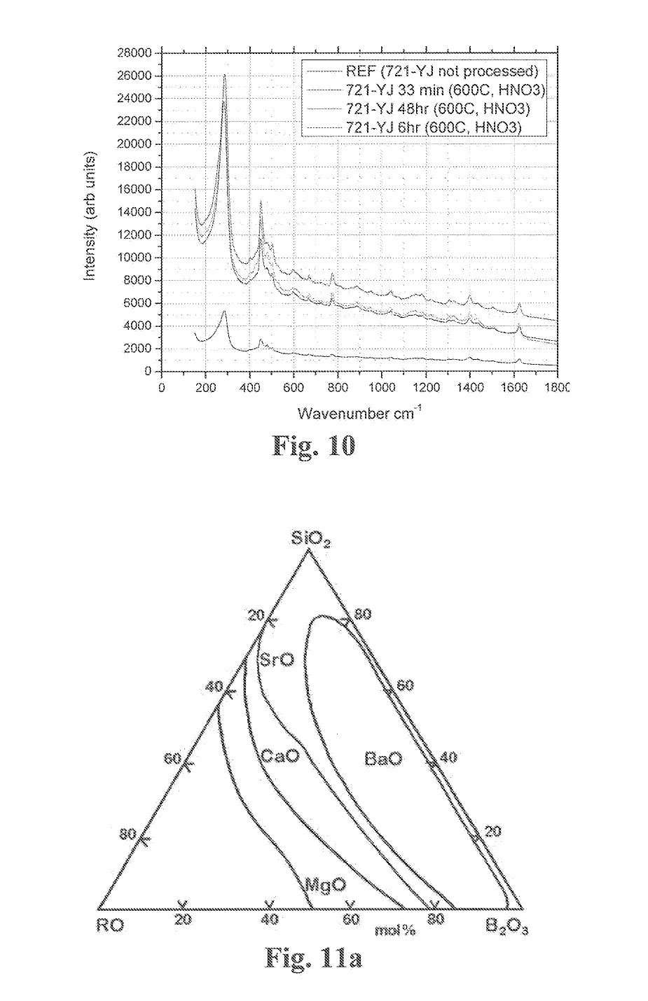

FIG. 10 shows SERS spectra of 10⁴ M methylene blue on glass (721-YJ) substrates (three top traces) that were annealed at various temperatures compared to an unprocessed glass (721-YJ) reference (baseline trace).

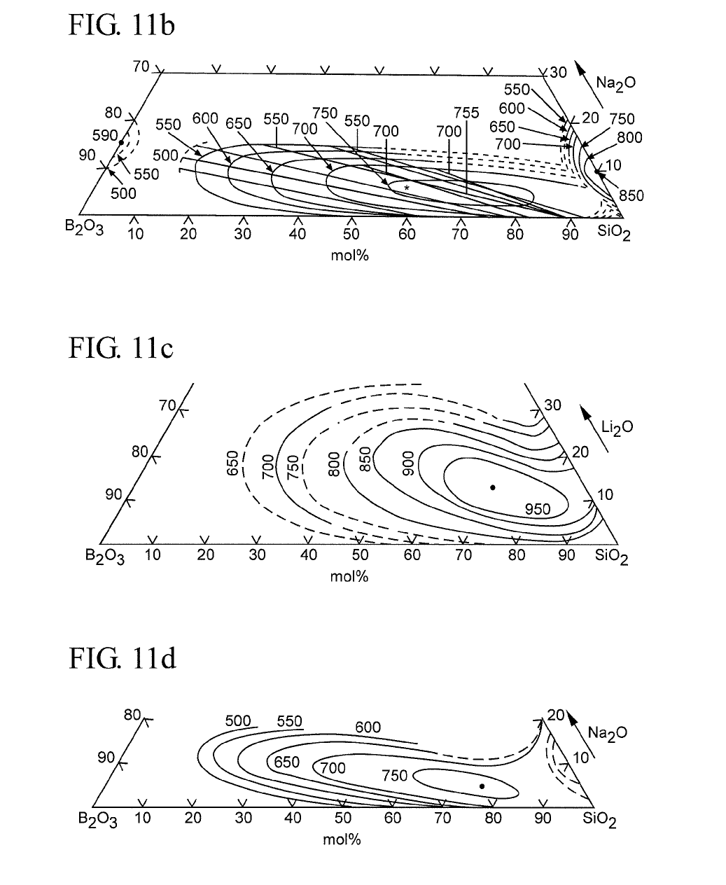

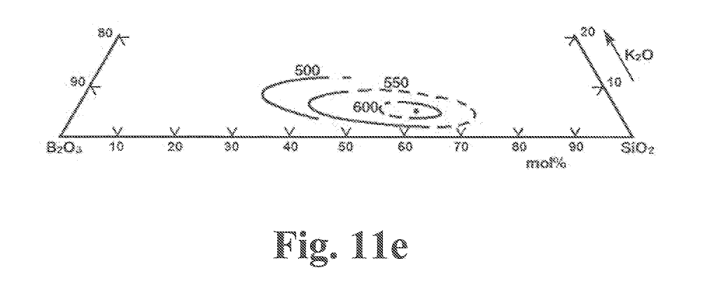

FIGS. 11a to 11e show phase diagrams, in mol % for: 11a) stable phase separation in the SiO₂—B₂O₃—RO system; 11b) metastable (sub-liquidus) phase separation in the SiO₂—B₂O₃—Na₂O system; 11c) metastable phase separation in the system SiO₂—B₂O₃—Li₂O; 11d) metastable phase separation in the SiO₂-B₂O₃—Na₂O system (previously published); and 11e) metastable phase separation in the SiO₂-B₂O₃—K₂O system.

In embodiments, the deposition of the metallic layer can use, for example, e-beam deposition or sputtering techniques. This substrate preparation can be abbreviated by using processes similar to those used for the nano-structured optical fiber manufacture. Specifically, glass soot consolidation can be used where, for example, the porosity and the density can be controlled, and the resulting glass, such as Vycor®, can be further improved for SERS-activation. This metal layer deposition allows for tailoring of the enhancement via SERS substrates based on varying anneal times, acid etch times, or both. FIG. 5 demonstrates the relationship between surface roughness and anneal (heat treatment in hours) time. By varying the surface roughness, the substrate used can be matched to the application. For assays that require very low detection limits or high signal-to-noise ratios, substrates with long anneal times, higher surface roughness features, i.e., higher fractal dimensions, can be selected to generate more sensitive substrates. Similarly, analytes such as straight chain hydrocarbons, or saturated ring structures which are not inherently strong SERS molecules, may benefit from a substrate tailored to give higher enhancement. Samples that are naturally good SER scatterers, for example, those with several degrees of unsaturation or highly aromatic ring structures like naphthalene, do not require the same degree of substrate roughness and can use an etched substrate with significantly shorter processing times.

In embodiments, bulk phase-separated, nano-structured substrates can be fabricated into arrayed wells. This can be accomplished using an intense, short pulsed or CW laser to swell or ablate the glass substrate into a prescribed closed, geometrical shape where a vertical wall of glass material is created.

In embodiments, a reflective coating can be applied to the underside of the SERS active substrate of an appropriate thickness to enable total internal reflection between both surfaces of the SERS active device. This reflective coating can be, for example, a metallic film, a dielectric film, or a combination thereof. Subsequent reflected radiation from the laser after it has been transmitted through the incident SERS-active surface can assist in the enhancement of the Raman signal as a result of the plasmonic interaction at the boundary of the noble metal coating applied to the incident SERS active surface.

### EXAMPLES

The following examples serve to more fully describe the manner of using the above-described disclosure, and the best modes contemplated for carrying out various aspects of the disclosure. It is understood that these examples do not limit the scope of this disclosure, but rather are presented for illustrative purposes.

### Example 1

Phase-Separated Borosilicate Glass Preparation. The following conditions were used to prepare a representative Eagle XG® substrate phase-separated borosilicate glass composition: anneal an Eagle XG® substrate sample at 790° C. for 90 min, then acidic etch for 3 hr with 5% HF and 10% HNO₃.

### Example 2

Other embodiments of the aforementioned procedure for phase-separation can include the following variants:
1. Etchant, for example a boron selective etchant, or silica selective etchant can be selected;
2. Etch time;
3. Anneal time (partial or full phase-separation, controls feature sizes);
4. Other glass compositions (Pyrex®, 2000-F, 1737-F, and 1737-F, Vycor®, 7070 (sodium silicate type glass));
5. substrate thickness as controlled, for example, by a fusion draw process;
6. arrayed phase-separated well plate via laser ablation;
7. re-homogenization of phase-separated glass surface layer via direct laser exposure;
8. application of a reflective coating on the substrate side opposite the etched and metalized surface; and
9. All ternary glass systems (RO—SiO₂—B₂O₃) or (R₂O—SiO₂—B₂O₃) where RO and R₂₀ includes various ratios of P₂O₅, MgO, CaO, SrO, BaO, GeO₂, TeO₂, SeO₂, As₂O₃, Sb₂O₃, V₂O, Na₂O, Li₂O, or K₂O, where the ternary glass system can phase separate along the SiO₂—B₂O₃ projection, see FIG. 11.

The disclosure has been described with reference to various specific embodiments and techniques. However, it should be understood that many variations and modifications are possible while remaining within the spirit and scope of the disclosure.

What is claimed is:

1. A process for controlling the surface nano-feature size of a phase-separated borosilicate glass composition, comprising:
annealing the borosilicate glass composition at just below the melting point of the glass for about 0.5 to about 200 hours;
contacting the resulting phase-separated glass with a suitable etchant for about 0.5 to about 120 minutes to dissolve one phase from the annealed borosilicate glass and to produce at least one porous surface; and
depositing a metal layer on the at least one porous surface.

2. The process of claim 1, wherein annealing is accomplished at from about 750 to about 800° C. in from about 30 to about 65 hours.

3. The process of claim 1 wherein contacting to dissolve one phase comprises treating the glass with a strong acid to dissolve the silica-rich phase, or treating the glass with a strong base to dissolve the boron-rich phase.

4. The process of claim 1, wherein contacting with a suitable etchant is accomplished in from about 20 to about 30 minutes.

5. The process of claim 1 wherein depositing the metal on the surface comprises sputtering, epitaxy, or a combination thereof.

6. The process of claim 1 wherein depositing the metal layer on the at least one porous surface is accomplished to a thickness of from about 1 to about 5,000 nm.

7. The process of claim 1 further comprising depositing metal on an opposing un-contacted side of the substrate to a thickness of from about 1 to about 5,000 nm.

8. The process of claim 1, wherein annealing is accomplished at from about 750 to about 800° C. in from about 30 to about 65 hours, and contacting with a suitable etchant is accomplished in from about 20 to about 30 minutes.

9. The process of claim 1, wherein the resulting at least one porous surface has pores having fractal particles within the pores, the pores having a width to height aspect ratio of from about 1:5 to about 50:200.

10. The process of claim 1 wherein the deposited metal layer has a thickness of about 1 to about 500 nm.

11. The method of claim 1 wherein the substrate has high optical clarity or transparency of from about 90 to about 99.5 percent.

12. The process of claim 1 wherein the phase-separated borosilicate glass composition comprises:
a separation in the SiO₂—B₂O₃—RO system;
a separation in the SiO₂—B₂O₃—R₂₀ system;
a separation in the SiO₂-B₂O₃—Na₂O system;
a separation in the system SiO₂-B₂O₃—Li₂O;
a separation in the SiO₂-B₂O₃—Na₂O system;
a separation in the SiO₂-B₂O₃-K₂O system;
or a combination thereof,
where RO and R₂₀ comprise at least one of P₂O₅, MgO, CaO, SrO, BaO, GeO₂, TeO₂, SeO₂, As₂O₃, Sb₂O₃, V₂O, Na₂O, Li₂O, K₂O, or a combination thereof.

13. A process for generating nanoscale features on a rigid, transparent substrate comprising:
sputtering atoms from a solid target onto the substrate, depositing partially sintered metal oxide soot onto the substrate, or a combination thereof, the solid target is a glass, a metal oxide soot, or a combination thereof, and the substrate is a phase-separated borosilicate glass composition of claim 13.

14. A SERS-active substrate comprising an article prepared according to claim 1.

15. A method of making a SERS active substrate comprising:
annealing a borosilicate glass composition at about 750 to about 800° C. for about 0.5 to about 65 hours;
contacting the resulting phase-separated glass with an etchant to dissolve one phase from the annealed borosilicate glass, and
depositing a metal layer having a thickness of from about 1 to about 5,000 nm on the etched surface of the resulting porous glass.

16. The method of claim 15 further comprising depositing a metal layer having a thickness of from about 1 to about 5,000 nm on an opposing non-etched surface of the resulting porous glass.

17. The method of claim 15 wherein the surface roughness of the etched surface increases with an increase in annealing time.

18. A method of SERS imaging comprising:
providing a SERS active substrate of claim 1 having a surface roughness based on the pores having a width to height aspect ratio of from about 1:5 to about 50:200;
providing an analyte to the surface of the SERS active substrate;
irradiating the analyte on the substrate; and
recording the light spectrum reflected from the substrate.

19. The method of claim 18 wherein the substrate is free of hot-spots.

20. The method of claim 18 wherein the background fluorescence decreases with an increase in the annealing period, and the signal-to-noise increases as the annealing period increases.
